(19) United States
(12) Patent Application Publication
(10) Pub. No.: US 2021/0339614 A1
(43) Pub. Date: Nov. 4, 2021

(54) Drive unit

(71) Applicant: Schaeffler Technologies AG & Co. KG, Herzogenaurach (DE)

(72) Inventor: Bernhard Walter, Oberkirch-Haslach (DE)

(73) Assignee: Schaeffler Technologies AG & Co. KG, Herzogenaurach (DE)

(21) Appl. No.: 17/280,961

(22) PCT Filed: Aug. 15, 2019
(86) PCT No.: PCT/DE2019/100735

§ 371 Date: Mar. 29, 2021

(30) Foreign Application Priority Data
Oct. 11, 2018 (DE) 10 2018 125 116.5

(51) Int. Cl. B60K 1/00; B60K 17/354; B60K 17/04

(52) U.S. Cl. CPC B60K 1/00; B60K 17/354; B60K 2001/001; B60Y 2400/72; B60K 17/04

(57) ABSTRACT

A drive unit includes a drive shaft, an electric machine for electrically generating a drive torque, a motor shaft for transmitting the drive torque, and a continuously variable transmission designed as a belt-driven conical disk transmission. The belt-driven conical disk transmission includes an input disk set coupled to the motor shaft, an output disk set coupled to the drive shaft, and a traction means for coupling the input disk set to the output disk set. The output disk set includes an output-side fixed disk that is axially immovable relative to the drive shaft, and an output-side floating disk unit with an output-side floating disk that is axially displaceable relative to the drive shaft to vary a first axial distance between the output-side floating disk and the output-side fixed disk. The output-side floating disk unit is arranged at least partially in a common axial area with the electric machine.

### CROSS-REFERENCE TO RELATED APPLICATIONS

This application is the United States National Phase of PCT Appln. No. PCT/DE2019/100735 filed Aug. 15, 2019, which claims priority to German Application No. DE102018125116.5 filed Oct. 11, 2018, the entire disclosures of which are incorporated by reference herein.

### TECHNICAL FIELD

The disclosure relates to a drive unit, with the aid of which a motor vehicle can be driven electrically.

### BACKGROUND

A drive unit for electrically driving a motor vehicle is known from US 2005/0006967 A1, in which a motor shaft of an electric motor, which is radially offset from a drive shaft, is toothed via two reducing spur gearings with a differential gear of the drive shaft.

### SUMMARY

According to the disclosure, a drive unit for electrically driving a motor vehicle is provided. The drive unit includes a drive shaft for driving a drive wheel, an electric machine for electrically generating a drive torque, a motor shaft arranged substantially axially parallel to the drive shaft for transmitting the drive torque generated in the electric machine, and a continuously variable transmission, e.g., designed as a belt-driven conical disk transmission. The continuously variable transmission has an input disk set coupled to the motor shaft and an output disk set coupled to the input disk set and to the drive shaft via a traction means. The output disk set has an output-side fixed disk that is immovable in the axial direction to the drive shaft and an output-side floating disk unit for optionally changing an axial distance of an output-side floating disk that is axially displaceable relative to the drive shaft to the output-side fixed disk. The output-side floating disk unit is arranged at least partially in a common axial area with the electric machine.

With the continuously variable transmission, the translation between the motor shaft and the drive shaft can be varied continuously so that, at a certain desired speed of the drive shaft, the electric machine can be operated close to the optimal operating point with a high degree of efficiency. This improves the efficiency of the drive unit. To change the transmission ratio, it is not necessary to interrupt the torque flow for a shifting process, so that the transmission ratio can be adjusted without interruption of the tractive force, which is perceived as comfortable.

The continuously variable transmission (CVT) designed, for example, as a belt-driven conical disk transmission, can couple the motor shaft and the drive shaft via a non-toothed traction means, in particular a V-belt. The traction means can slip in the event of a sudden torque surge and damage to components of the drive unit by the torque surge can thereby be avoided. Due to the substantially axially parallel arrangement of the electric machine and the motor shaft to the drive shaft, it is not necessary to provide the electric machine coaxially to the drive shaft, so that it is possible in principle to keep the axial extent of the drive shaft small. For example, in the case of a small car with a small vehicle width, the electric drive option can be implemented in the limited installation space available.

In addition, it is possible to plug the electric machine into the continuously variable transmission and nest it. In a plane including the motor shaft and the drive shaft, viewed in the radial direction, at least part of the output-side floating disk unit can cover part of the electric machine. This leads to a more compact structure in which axial installation space can be saved.

Here, use is made of the knowledge that, due to the actuators provided for the axial displacement of the floating disk, the floating disk unit has a greater axial extent than the fixed disk. If the floating disk units of the input disk set and the output disk set are provided on different axial sides, the electric machine can be arranged adjacent to the narrow fixed disk of the input disk set, and the electric machine can be partially positioned in a common axial area with the floating disk unit of the output disk set. This creates free installation space on the fixed disk of the output disk set in a common axial area with the floating disk unit of the input disk set, in which additional components can be arranged, and the overall installation space requirement of the drive unit can be reduced.

An installation space that is otherwise difficult to use between the electric machine and the drive shaft can be better utilized by the output-side floating disk unit. An efficient and space-saving drive unit of a motor vehicle is possible due to the arrangement of the output-side floating disk unit of the continuously variable transmission next to the electrical machine.

The continuously variable transmission (CVT), is designed, for example, as a belt-driven conical disk transmission. The transmission ratio and thus the transmitted torque and the transmitted speed can be continuously changed by changing the axial distance between an input-side conical disk and the correspondingly designed input-side counter disk, and a corresponding change in the axial distance between an output-side conical disk and the corresponding designed output-side counter disk.

The minimum and maximum transmission ratios of the continuously variable transmission are defined by the minimum and the maximum effective diameter of the input-side and output-side conical disk set on the belt. The shaft of the input-side conical disk set can be coupled to the motor shaft of the electric machine or can form the motor shaft. The shaft of the output-side conical disk set can be coupled to the drive shaft or can form the drive shaft.

In an example embodiment, the electric machine has an electrically operable stator and a rotor connected to the motor shaft. The stator has a support, e.g., designed as an iron core, and current-flowing stator windings provided in the support and the output-side floating disk unit are at least partially arranged in a common axial area with the support and/or with the stator windings. If the rotor is to be designed to be shorter than the stator in the axial direction, the support and/or the stator windings are used for the common axial area of the electric machine with the output-side floating disk unit.

The end windings of the stator windings may protrude from the support in the axial direction and the output-side floating disk unit may be at least partially arranged in a common axial area with the end windings offset axially from the support. Due to the protruding end windings, the electromagnetic effect of the stator can be maximized and simple electrical contact can be achieved. At the same time, a step can result in the external dimensions of the electric machine between the support and the end windings of the stator windings protruding from the support, the installation space of which can be used for the collision-free positioning of the output-side floating disk unit. It is even possible for the output-side floating disk unit to be arranged so close to the end windings that, viewed in the axial direction of the stator, part of the support and part of the output-side floating disk unit overlap. This leads to a compact and space-saving design of the drive unit, in which the distance between the motor shaft and the drive shaft can be minimized.

The output-side floating disk unit may have a housing for guiding the axially displaceable output-side floating disk. The housing, e.g., at least a large part of the housing, is arranged in a common axial area with the electric machine. For example, in an axially maximally distanced relative position of the floating disk to the fixed disk, the floating disk can be positioned in a common axial area with the electric machine. It is, in principle, possible that the floating disk is arranged axially as close as possible relative to the fixed disk axially outside the area of the axial area occupied by the electric machine. The housing, which is fixed in the axial direction, is arranged in each relative position of the floating disk at least partially in a common axial area with the electric machine.

In an example embodiment, the input disk set has an input-side fixed disk which is immovable in the axial direction relative to the motor shaft and an input-side floating disk unit for optionally changing an axial distance of an input-side floating disk, that is axially displaceable relative to the motor shaft, relative to the input-side fixed disk, and the input-side floating disk unit is provided on an axial side of the input disk set facing away from the electric machine. The floating disk units of the input disk set and the output disk set can be provided on different sides of the continuously variable transmission. As a result, the wider, output-side floating disk unit can be positioned opposite the narrower input-side fixed disk, so that the electric machine can be arranged in part in a common axial area with the output-side floating disk unit.

The output disk set may be indirectly coupled to the drive shaft via a reduction stage, and the reduction stage may be arranged at least partially in a common axial area with the input disk set, e.g., the input-side floating disk unit. The reduction stage can provide a further fixed translation or reduction so that a desired speed range of the drive shaft can be better realized with the electric machine. By positioning the reduction stage next to the input disk set, the axial installation space requirement can be reduced.

The output disk set may be indirectly coupled via a differential gear with two drive shafts each leading to a drive wheel, and the differential gear may be arranged at least partially in a common axial area with the input disk set, e.g., the input-side floating disk unit. The differential gear enables automatic adaptation of the required speeds of the drive wheels coupled to the respective drive shaft when cornering. By positioning the differential gear next to the input disk set, the axial installation space requirement can be reduced.

In an example embodiment, the output disk set is arranged coaxially to the drive shaft, and the output disk set, for example, has a hollow shaft connected to the output-side fixed disk for passage of the drive shaft. This makes it possible to achieve a fixed speed reduction between the output disk set and the drive shaft with a single planetary gear. The number of components can thus be kept low.

The input disk set may be arranged coaxially to the motor shaft, the input disk set may have a hollow shaft connected to the input-side fixed disk for passage of the motor shaft, and the input disk set may be indirectly coupled to the motor shaft via a pre-reduction stage. This makes it possible to achieve a fixed speed reduction between the motor shaft and the input disk set with just one planetary gear. The number of components can thus be kept low. Here, it is possible either to provide only the input-side pre-reduction stage, only the output-side reduction stage, or to provide both the input-side pre-reduction stage and the output-side reduction stage at the same time.

The pre-reduction stage may be arranged at least partially in a common axial area with a reduction stage and/or differential gear provided in the torque flow between the output disk set and the drive shaft. By positioning the pre-reduction stage next to the reduction stage and/or next to the differential gear, the axial installation space requirement can be reduced.

### BRIEF DESCRIPTION OF THE DRAWINGS

In the following, the disclosure is explained by way of example with reference to the accompanying drawings using exemplary embodiments, in which the features shown below can represent an aspect of the disclosure both individually and in combination. In the figures:

FIG. 1 shows a schematic diagram of a first embodiment of a drive unit;

FIG. 2 shows a schematic diagram of a second embodiment of a drive unit; and

FIG. 3 shows a schematic section view of the drive unit from FIG. 1.

### DETAILED DESCRIPTION

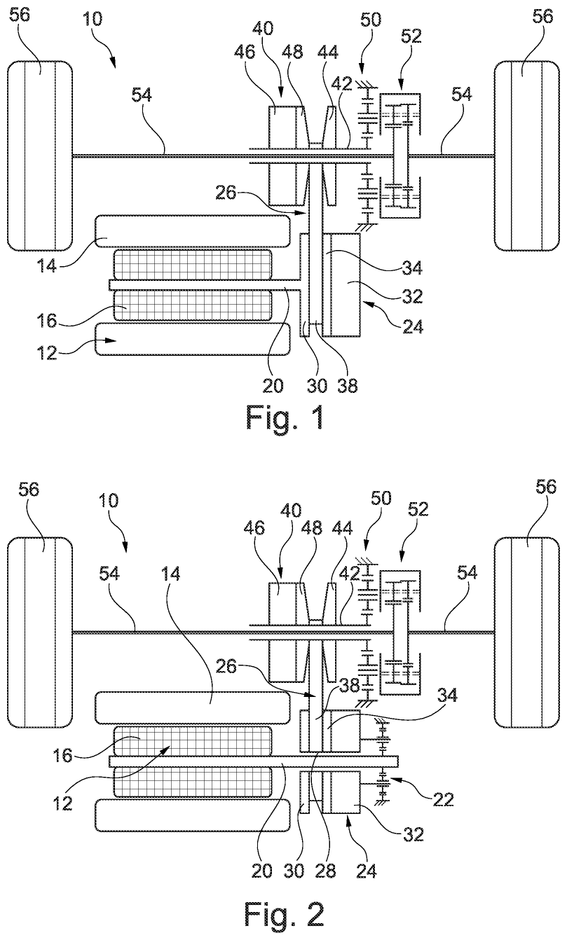

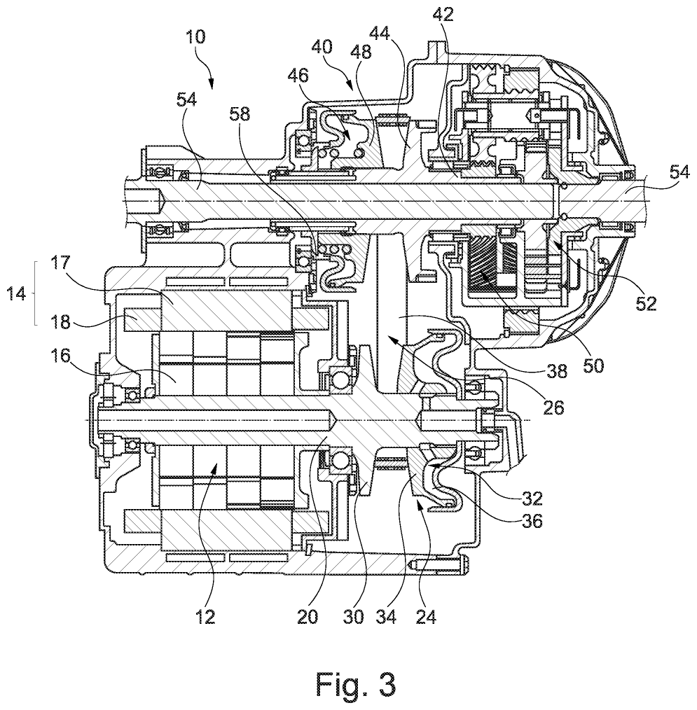

The drive unit 10 of an electrically drivable motor vehicle illustrated in FIG. 1 and FIG. 3 has an electric machine 12 with a stator 14 and a rotor 16. The rotor 16 can have a support 17 which has a smaller axial extension than the rotor 16 and in which stator windings through which current flows are embedded. The stator windings can have end windings 18 protruding from the support 17 in the axial direction. The rotor 16 is connected in a rotationally fixed manner to a motor shaft 20, which in turn is coupled to an input disk set 24 of a continuously variable transmission 26 configured as a belt-driven conical disk transmission.

The input disk set 24 has an input-side fixed disk 30 connected in a rotationally fixed manner to the motor shaft 20 and an input-side floating disk unit 32. The input-side floating disk unit 32 has an input-side floating disk 34 which is axially displaceable relative to the input-side fixed disk 30 and which, with the aid of a hydraulic pressure built up in an input-side pressure chamber 36, can be displaced against the spring force of a restoring spring, in order to displace a traction means 38, designed to be pressed between the input-side fixed disk 30 and the input-side floating disk 34 as a V-belt for continuously changing a transmission ratio of the continuously variable transmission 26 to a different effective radius.

An output disk set 40 is coupled to the input disk set 24 via the traction means 38. The output disk set 40 has an output-side fixed disk 44 connected to an output-side hollow shaft 42 and an output-side floating disk unit 46. An output-side floating disk unit 46 has an output-side floating disk 48 which is axially displaceable relative to the output-side fixed disk 44 and which can press the traction means 38 between the output-side fixed disk 44 and the output-side floating disk 48. The output-side hollow shaft 42 is coupled via a reduction stage 50 designed as precisely one planetary gear to a differential gear 52, from which two drive shafts 54 extend. A drive wheel 56 is coupled to each drive shaft 54.

The input-side floating disk unit 32 and the output-side floating disk unit 46 are provided on different sides of the continuously variable transmission 26, and the electric machine 12 is positioned adjacent to the input-side fixed disk 30. As a result, the output-side floating disk unit 46 can be arranged with at least one housing 58 in a common axial area with the electric machine 12 in a space-saving manner. At least the housing 58 and the end windings 18 protruding from the support 17 of the stator 14 can be arranged at least partially in a common axial area, so that, in a plane including the motor shaft 20 and the drive shaft 54 viewed in the radial direction, part of the output-side floating disk unit 46 and a part of the electric machine 12 overlap.

In the embodiment of the drive unit 10 shown in FIG. 2, in comparison to the embodiment of the drive unit 10 shown in FIG. 1, a pre-reduction stage 22 is provided on the input side between the motor shaft 20 and the input disk set 24. For this purpose, the motor shaft 20 is coupled via the pre-reduction stage 22 to an input-side hollow shaft 28 of the input disk set 24, through which the motor shaft 20 is passed. The input-side hollow shaft 28 is connected to an output of the pre-reduction stage 22 configured as precisely one planetary gear and the input-side fixed disk 30. The pre-reduction stage 22 is arranged in a common axial area with the reduction stage 50 and/or the differential gear 52 in an installation space-saving manner.

### REFERENCE NUMERALS

10 Drive unit

12 Electric machine

14 Stator

16 Rotor

17 Support

18 End windings

20 Motor shaft

22 Pre-reduction stage

24 Input disk set

26 Continuously variable transmission

28 Input-side hollow shaft

30 Input-side fixed disk

32 Input-side floating disk unit

34 Input-side floating disk

36 Input-side pressure chamber

38 Traction means

40 Output disk set

42 Output-side hollow shaft

44 Output-side fixed disk

46 Output-side floating disk unit

48 Output-side floating disk

50 Reduction stage

52 Differential gear

54 Drive shaft

56 Drive wheel

58 Housing

1.-10. (canceled)

11. A drive unit for electrically driving a motor vehicle, comprising:
a drive shaft for driving a drive wheel;
an electric machine for electrically generating a drive torque;
a motor shaft arranged substantially axially parallel to the drive shaft for transmitting the drive torque; and
a continuously variable transmission designed as a belt-driven conical disk transmission, the belt-drive conical disk transmission comprising:
an input disk set coupled to the motor shaft;
an output disk set coupled to the drive shaft, comprising:
an output-side fixed disk that is axially immovable relative to the drive shaft; and
an output-side floating disk unit comprising an output-side floating disk that is axially displaceable relative to the drive shaft to vary a first axial distance between the output-side floating disk and the output-side fixed disk; and
a traction means for coupling the input disk set to the output disk set, wherein the output-side floating disk unit is arranged at least partially in a common axial area with the electric machine.

12. The drive unit of claim 11 wherein the traction means is a V-belt.

13. The drive unit of claim 11, wherein the electric machine comprises:
an electrically operable stator comprising:
a support; and
current-flowing stator windings provided in the support; and
a rotor connected to the motor shaft, wherein the output-side floating disk unit is at least partially arranged in a common axial area with:
the support; or
the current-flowing stator windings.

14. The drive unit of claim 13 wherein the support is an iron core.

15. The drive unit of claim 13, wherein:
the current-flowing stator windings comprise end windings that axially protrude from the support; and
the output-side floating disk unit is arranged at least partially in a common axial area with the end windings.

16. The drive unit of claim 11, wherein:
the output-side floating disk unit comprises a housing for guiding the output-side floating disk; and
at least a part of the housing is arranged in a common axial area with the electric machine.

17. The drive unit of claim 11, wherein:
the input disk set comprises:
an input-side fixed disk that is axially immovable relative to the motor shaft; and
an input-side floating disk unit comprising an input-side floating disk that is axially displaceable relative to the motor shaft to vary a second axial distance between the input-side floating disk and the input-side fixed disk; and
the input-side floating disk unit is provided on an axial side of the input disk set facing away from the electric machine.

18. The drive unit of claim 17, wherein:
the output disk set is indirectly coupled to the drive shaft via a reduction stage; and
the reduction stage is arranged at least partially in a common axial area with the input disk set.

19. The drive unit of claim 18, wherein the reduction stage is arranged at least partially in a common axial area with the input-side floating disk unit.

20. The drive unit of claim 17, wherein:
the output disk set is indirectly coupled to two drive shafts via a differential gear;
each of the two drive shafts leads to a respective drive wheel; and
the differential gear is arranged at least partially in a common axial area with the input disk set.

21. The drive unit of claim 20 wherein the differential gear is arranged at least partially in a common axial area with the input-side floating disk unit.

22. The drive unit of claim 11, wherein:
the output disk set is indirectly coupled to the drive shaft via a reduction stage; and
the reduction stage is arranged at least partially in a common axial area with the input disk set.

23. The drive unit of claim 11, wherein:
the output disk set is indirectly coupled to two drive shafts via a differential gear;
each of the two drive shafts leads to a respective drive wheel; and
the differential gear is arranged at least partially in a common axial area with the input disk set.

24. The drive unit of claim 11, wherein the output disk set is arranged coaxially to the drive shaft.

25. The drive unit of claim 24, wherein the output disk set comprises a hollow shaft connected to the output-side fixed disk for passage of the drive shaft.

26. The drive unit of claim 11, wherein:
the input disk set is arranged coaxially to the motor shaft;
the input disk set has a hollow shaft connected to an input-side fixed disk for passage of the motor shaft; and
the input disk set is indirectly coupled to the motor shaft via a pre-reduction stage.

27. The drive unit of claim 26, wherein the pre-reduction stage is arranged at least partially in a common axial area with a reduction stage or a differential gear provided in a torque flow between the output disk set and the drive shaft.
